(19) United States
(12) Patent Application Publication
(10) Pub. No.: US 2013/0096741 A1
(43) Pub. Date: Apr. 18, 2013

(54) APPARATUS AND METHOD FOR CONTROLLING TRAIN SPEED

(71) Applicants: Jong Chul JUNG, Seoul (KR); Yong Gee CHO, Seoul (KR)

(72) Inventors: Jong Chul JUNG, Seoul (KR); Yong Gee CHO, Seoul (KR)

(73) Assignee: LSIS CO., LTD., Anyang-si (KR)

(21) Appl. No.: 13/615,616

(22) Filed: Sep. 14, 2012

(30) Foreign Application Priority Data
Oct. 18, 2011 (KR) 10-2011-0106333

(51) Int. Cl. G06F 19/00

(52) U.S. Cl. 701/20

(57) ABSTRACT

An apparatus and method for controlling train speed are disclosed, the method including receiving an operation data, estimating a future train speed subsequent to a predetermined time of the train, using the operation data and dynamics model of a train, calculating a TTSLC {Time-To-Speed-Limit Crossing, a time when the train exceeds an ATP (Automatic Train Protection) speed limit}, and outputting a deceleration command by determining an additional braking force, in a case the TTSLC is smaller than a predetermined threshold.

Pursuant to 35 U.S.C.§119(a), this application claims the benefit of earlier filing date and right of priority to Korean Patent Application No. 10-2011-0106333, filed on Oct. 18, 2011, the contents of which are hereby incorporated by reference in their entirety.

### BACKGROUND OF THE DISCLOSURE

1. Field of the Disclosure

The present disclosure relates to a control technique of train speed.

2. Discussion of the Related Art

This section provides background information related to the present disclosure which is not necessarily prior art.

In general, an object of automatic train operation (running) is to enable the train to run at a predetermined target speed at each operation section, and to effectively and safely stop at a designated position at a train station.

The automatic train operation may be effected without a driver, and even if a driver is available, the driver is not proactively involved in the operation of a train, but provided with a minimum part of performing a brake of the train when there is generated an emergency.

In case of a CBTC (Communication-Based Train Control) that is operated by radio communication, protection of train is performed by ATP (Automatic Train Protection) system, and operation such as control of train speed is performed by ATO (Automatic Train Operation) system.

The ATP system sets up an ATP speed profile or ATP speed limit in consideration of various factors including speed limit of a train at each section, stop position in response to movement authority and safety brake model. The speed limit is transmitted to the ATO system, where the ATO system generates an ATO speed profile in consideration of various factors such as ride comfort or adhesion coefficient, lest the train exceed the limit.

Then, a controller measures a current speed and transmits deceleration/acceleration command to the train to follow the ATO speed profile. Subsequently, the train runs in response to the generated ATO speed profile.

FIG. 1 is a graph illustrating control of a train speed according to prior art.

Referring to FIG. 1, T1 is a current time, Tw is a time when a train exceeds an ATP speed limit for warning, and T2 is a time when the train exceeds an ATP speed limit for emergency braking Although a train runs in response to the ATO speed profile (not shown), if the train exceeds the ATP speed profile or the ATP speed limit, the ATP system activates an emergency brake to eventually stop the train.

To be more specific, although variable according to systems, the ATP speed limit is provided in two types, that is, one is the ATP speed limit for warning and the other is the ATP speed limit for emergency braking, and if the train exceeds the ATP speed limit for warning, the ATP system transmits warning to a driver or a supervisor. However, if the train speed exceeds the ATP speed limit for emergency braking, because no subsequent follow-up action is made in response to the transmitted warning, the train is stopped.

That is, if the train is running at the train speed illustrated in FIG. 1, the ATP system transmits a warning signal to the driver or the supervisor at Tw, and transmits an emergency braking command to the train at T2, whereby the train is stopped by the emergency braking.

As noted from the foregoing, in the conventional automatic train operation system, the ATO generates an ATO speed profile based on the ATP-generated ATP speed limit, and transmits propulsive or braking command to enable a train to trace (follow) the ATO speed profile while not exceeding the ATP speed limit, whereby a train safety is guaranteed.

Thus, in the system like the above, it is general that a safety margin is greatly provided when generating the ATO speed profile to prevent the emergency braking from happening during train operation. Therefore, there is no way but to adopt an operation method based on a conservative viewpoint where a gap between a set value and an allowable limit value is enlarged. That is, there is no way but to allow a train to run at a low speed for fear of an emergency braking being possibly performed, even if the train can run at a faster speed.

Thus, the conventional train operation system suffers from disadvantages in that a train operation frequency at a relevant line is reduced to decrease operational efficiency in the economic viewpoint.

### SUMMARY OF THE DISCLOSURE

This section provides a general summary of the disclosure, and is not a comprehensive disclosure of its full scope or all of its features.

Exemplary aspects of the present disclosure are to substantially solve at least the above problems and/or disadvantages and to provide at least the advantages below. Accordingly, an aspect of the present disclosure provides an apparatus for controlling train speed configured to prevent an emergency braking of the train by predicting a time when a train exceeds an ATP speed limit at ATO of the train, and to enable economic and effective train operation by minimizing safety margin during generation of ATO speed profile, and a method using the same.

It should be emphasized, however, that the present disclosure is not limited to a particular disclosure, as explained above. It should be understood that other technical subjects not mentioned herein may be appreciated by those skilled in the art.

In one general aspect of the present disclosure, there is provided an apparatus for controlling train speed, the apparatus comprising: an estimation unit estimating a future speed subsequent to a predetermined time of the train, using an operation data and a dynamics model of the train; a calculation unit calculating a TTSLC {Time-To-Speed-Limit Crossing, a time when the train exceeds an ATP (Automatic Train Protection) speed limit}, using the future speed estimated by the estimation unit; and a first controller outputting a deceleration command by determining an additional braking force, in a case the TTSLC is smaller than a predetermined threshold.

In some exemplary embodiments, the apparatus further comprises: a generation unit generating an ATO (Automatic Train Operation) speed profile using the ATP speed limit and PSM (Precision Stopping Marker) sensor data; and a second controller outputting deceleration/acceleration commands by comparing a current speed provided by the train and the ATO speed profile and by determining speed decrement/increment of the train.

In some exemplary embodiments, the operation data includes tractive force, braking force and acceleration.

In some exemplary embodiments, the estimation unit estimating a current train speed using the tractive force, the braking force and the acceleration of the train, and estimating a future train speed subsequent to the predetermined time of the train, using the current train speed and the dynamics model of the train.

In some exemplary embodiments, the operation data includes tractive force, braking force and acceleration of the train.

In some exemplary embodiments, the estimation unit estimates the future train speed subsequent to the predetermined time of the train using the current train speed and the dynamics model of the train.

In some exemplary embodiments, the first controller presets a the predetermined threshold relative to the TTSLC in consideration of a train characteristic.

In some exemplary embodiments, the apparatus further comprises an adding unit adding deceleration command of the first controller to the deceleration/acceleration command of the second controller and outputs the addition to the train.

In another general aspect of the present disclosure, there is provided a method for controlling train speed, the method comprising: receiving an operation data; estimating a future train speed subsequent to a predetermined time of the train, using the operation data and dynamics model of a train; calculating a TTSLC {Time-To-Speed-Limit Crossing, a time when the train exceeds an ATP (Automatic Train Protection) speed limit}; and outputting a deceleration command by determining an additional braking force, in a case the TTSLC is smaller than a predetermined threshold.

In some exemplary embodiments, the method further comprises estimating a current train speed, using the operation data.

In some exemplary embodiments, the operation data includes tractive force, braking force and acceleration of the train.

In some exemplary embodiments, the operation data includes tractive force, braking force and current speed of the train.

In some exemplary embodiments, the method further comprises generating an ATO (Automatic Train Operation) speed profile using the ATP speed limit and PSM (Precision Stopping Marker) sensor data; and outputting deceleration/acceleration commands by comparing a current speed provided by the train and the ATO speed profile and by determining speed decrement/increment of the train.

In some exemplary embodiments, the method further comprises adding the deceleration command to the deceleration/acceleration commands and outputting the addition to the train.

The apparatus and method for controlling train speed according to exemplary embodiments of the present disclosure have an advantageous effect in that a future train speed is anticipated from a current train speed to predict at which point a train exceeds a predetermined ATP speed limit, and an additional service braking force is provided before the train reaches the predetermined ATP speed limit to enable the train to safely run.

Another advantageous effect is that a future train speed can be anticipated to prevent an emergency braking caused by exceeded ATP speed limit from occurring. Still another advantageous effect is that a minimum safety margin is provided when generating ATO speed profile to increase a train speed during operation of the train, resultantly increasing operation frequency of the train and enhancing availability of train.

Other exemplary aspects, advantages, and salient features of the disclosure will become more apparent to persons of ordinary skill in the art from the following detailed description, which, taken in conjunction with the annexed drawings, discloses exemplary embodiments of the invention.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a graph illustrating control of train speed according to prior art;

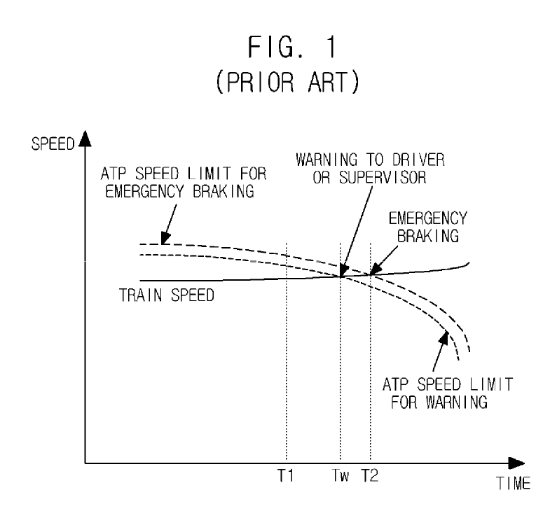

FIG. 2 is an exemplary graph illustrating the definition of TTSLC used in the present disclosure;

FIG. 3 is a block diagram illustrating an apparatus for controlling train speed according to an exemplary embodiment of the present disclosure;

FIG. 4 is a flowchart illustrating a method for controlling train speed according to the present disclosure;

FIG. 5 is a block diagram illustrating an apparatus for controlling train speed according to another exemplary embodiment of the present disclosure.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

It is to be understood that both the foregoing general description and the following detailed description of the present disclosure are exemplary and explanatory and are intended to provide further explanation of the disclosure as claimed.

### DETAILED DESCRIPTION

Hereinafter, exemplary embodiments of the present disclosure will be described in detail with reference to the accompanying drawings.

In describing the present disclosure, detailed descriptions of constructions or processes known in the art may be omitted to avoid obscuring appreciation of the invention by a person of ordinary skill in the art with unnecessary detail regarding such known constructions and functions. Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

Unless specifically stated otherwise, as apparent from the following discussions, it should be understood that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The suffixes ‘module’, ‘unit’ and ‘part’ may be used for elements in order to facilitate the disclosure. Significant meanings or roles may not be given to the suffixes themselves and it is understood that the ‘module’, ‘unit’ and ‘part’ may be used together or interchangeably. That is, the terms “-er”, “-or”, “part” and “module” described in the specification mean units for processing at least one function and operation and can be implemented by hardware components or software components, and combinations thereof.

As used herein, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout and explanations that duplicate one another will be omitted.

It will be understood that when an element is referred to as being “connected” or “coupled” to another element, it can be directly connected or coupled to the other elements or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise.

A train speed limit allowable as being safe on ATP (Automatic Train Protection) is set for safe operation of train on a radio communication system. Then, the train is run in response to a train operation strategy within a scope not exceeding the train speed limit on ATO (Automatic Train Operation) system.

If the train exceeds the speed limit at any given moment, the ATP outputs an emergency braking command for train safety to protect the train whereby the train can be safely stopped. That is, the ATO generates an ATO speed profile to be followed by the train in consideration of ride comfort, operation strategy and braking performance based on ATP speed limit received from the ATP.

The ATO compares the ATO speed profile with a current train speed, inputs tractive and braking commands to fraction and braking devices, and allows the train to trace or follow the designated ATO speed profile.

However, if the train speed exceeds the ATP speed limit at any given moment, the train is provided with an emergency braking immediately, such that it is customary to generate an ATO speed profile with a large safety margin so that the train is prevented from exceeding the ATP speed limit.

The present disclosure relates to a train speed limit of ATO which is an automatic train operation apparatus, and uses a model-based observer design to predict a future train speed, calculates that the train will exceed the ATP speed limit in such and such seconds, and prevents the train from being confronted with a dangerous situation by performing a service braking operation, before the train exceeds the speed limit to allow being emergently braked.

That is, a TTSLC {Time-To-Speed-Limit Crossing, a time when the train exceeds an ATP (Automatic Train Protection) speed limit} is defined, and if the TTSLC is smaller than a predetermined allowable time, the train speed is reduced to prevent the train from being emergently braked.

The present disclosure is advantageous in that a time can be predicted when a train exceeds a speed limit under a current time period and an emergency braking is performed after the train is operated to enable a safe operation, and a safety margin is minimized when a speed profile is set up to enable a more effective train operation.

Now, exemplary embodiments of the present disclosure will be described with reference to the accompanying drawings.

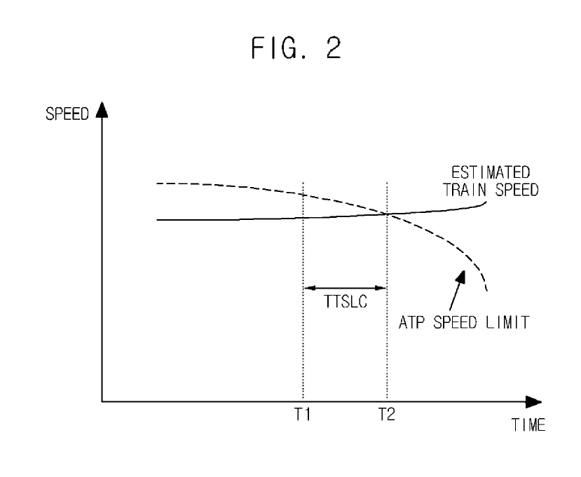

FIG. 2 is an exemplary graph illustrating the definition of TTSLC used in the present disclosure.

Referring to FIG. 2, assuming that a current time is T1, and a time exceeding an ATP speed limit is T2, a TTSLC used in the present disclosure is a difference between T2 and T1.

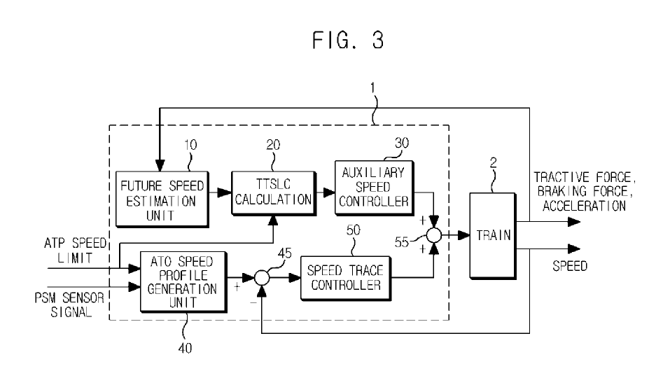

FIG. 3 is a block diagram illustrating an apparatus for controlling train speed according to an exemplary embodiment of the present disclosure.

Referring to FIG. 3, an apparatus (1) for controlling train speed according to an exemplary embodiment of the present disclosure (hereinafter referred to as “apparatus”) comprises a future speed estimation unit (10), a TTSLC calculation unit (20), an auxiliary speed controller (30), an ATO speed profile generation unit (40) and a speed trace controller (50), and controls the train (2) speed.

The future speed estimation unit (10) estimates a current train speed using operation data (e.g., tractive force, braking force and acceleration) received from the train (2) and a dynamics model at the current time to estimate a current train speed and predict a train speed subsequent to n step.

Thus, a longitudinal dynamics model of the train (2) is needed in order to estimate the train speed subsequent to n step of the future train speed estimation unit (10), the detail of which is now described.

First, the longitudinal dynamics model of the train (2) may be obtained from the following equation using Newton's second law, if movement of the train (2) of crosswise directions is small enough to be disregarded.

$$m \frac{d v}{d t} = {T}_{e} - {T}_{b} - {R}_{r} - {R}_{g} - {R}_{c} \qquad [ Equation 1 ]$$

Where, m is a train equivalent mass of the train (2), v is a train longitudinal speed of the train (2), Tₑ is a tractive force, T_{b} is a braking force, Rᵣ is a running resistance formed by adding a rolling resistance and an aerodynamic drag. Furthermore, R_{g} is a grade resistance, and R_{c} is a curving resistance.

The train equivalent mass m of (2) is defined by an imagination of a lumped mass, although the train (2) is substantially formed by connecting several rolling stocks. The tractive force Tₑ and the braking force T_{b} are respectively received from a tractive device (not shown) and a braking device (not shown) of the train. (2).

The running resistance Rᵣ of train (2) is expressed by a sum of the rolling resistance and aerodynamic drag, and may be modeled by the following quadratic equation to speed.

R=c₁+c₂v+c₃v², [Equation 2]

where c₁, c₂ and c₃ are respectively constants, the quadratic term to the speed is an equation to aerodynamic drag, linear and constant terms to speed are expression to rolling resistance.

The grade resistance R_{g} may be expressed by a relational expression to the train equivalent mass m and grade level of the train as shown in the following Equation 3.

R_{g}=mgθ, [Equation 3]

where g is a gravitational acceleration, θ is gradient angle. That is, if there is almost no inclination, the grade resistance R_{g} may be disregarded.

Furthermore, the curving resistance R_{c} is a function to curvature radius, and may be expressed by the following Equation 4.

$${R}_{c} = \frac{{c}_{4}}{r} \qquad [ Equation 4 ]$$

where, c₄ is a constant, r is a curvature radius.

The future speed estimation unit (10) predicts a future train speed using a current operation data of train (2). To this end, the future speed estimation unit (10) uses the dynamics model of train (2).

Discretization of the longitudinal dynamics model of train (2) in Equation 1 may be expressed by the following Equation 5.

$$v ( k ) = v ( k - 1 ) + \frac{Δ T}{m} [ {T}_{e} ( k - 1 ) - {T}_{b} ( k - 1 ) - {c}_{5} - {c}_{2} v ( k - 1 ) - {c}_{3} {v ( k - 1 )}^{2} ] \qquad [ Equation 5 ]$$

where, c₅=R_{g}+R_{c}+c₁, and may be defined by a sum of items that can be expressed by constants such as curve resistance and curving resistance, and ΔT is a sampling period.

An observer capable of estimating a current train sped may be designed using the above Equation 5. Various types of observer capable of estimating state variables in a non-linear system are available, but the speed estimation is performed using a simply designable extended Kalman filter in the present disclosure. However, the extended Kalman filter is just an example, and it should be apparent to the skilled in the art that use of other observers than the extended Kalman filter as an observer design for estimating the train speed is not ruled out.

A current speed estimation using the extended Kalman filter may be expressed by the following Equations.

$$\begin{matrix}\hat{v} ( k \vert k - 1 ) = \hat{v} ( k - 1 \vert k - 1 ) + \frac{Δ T}{m} [ - {c}_{2} \hat{v} ( k - 1 \vert k - 1 ) - {c}_{3} {\hat{v} ( k - 1 \vert k - 1 )}^{2} ] + \frac{Δ T}{m} [ {T}_{e} ( k - 1 ) - {T}_{b} ( k - 1 ) - {c}_{5} ] & [ Equation 6 ] \\ P ( k \vert k - 1 ) = F ( k - 1 ) P ( k - 1 \vert k - 1 ) {F ( k - 1 )}^{T} + Q ( k - 1 ) & [ Equation 7 ] \\ \hat{y} ( k \vert k - 1 ) = \frac{1}{m} [ {T}_{e} ( k ) - {T}_{b} ( k ) - {c}_{5} - {c}_{2} \hat{v} ( k \vert k - 1 ) - {c}_{3} {\hat{v} ( k \vert k - 1 )}^{2} ] & [ Equation 8 ] \\ L ( k ) = P ( k \vert k - 1 ) {H ( k )}^{T} ( H ( k ) P ( k \vert k - 1 ) {H ( k )}^{T} + {R ( k )}^{- 1} & [ Equation 9 ] \\ \hat{v} ( k \vert k ) = \hat{v} ( k \vert k - 1 ) + L ( k ) ( y ( k ) - \hat{y} ( k \vert k - 1 ) ) & [ Equation 10 ]\end{matrix}$$

where, L(k) is a gain of Kalman filter, and y(k) is an acceleration of a train (2) obtained from an acceleration sensor (not shown) attached to the train (2). Q(k+1) and R(k) are error covariance by a process noise and a sensor noise. Furthermore, F (k+1) is a Jacobian matrix of process model expressed by the Equation 5 relative to state variable, and H(k) is a Jacobian matrix relative to state variable of measurement model.

In view of the Equation 10, it can be noted that a correction value is used for estimating speed by multiplying a difference between the measured acceleration and the speed estimated by the Equation 8 by the gain L(k).

The Kalman filter gain L(k) is appropriately determined in consideration of observer stability and convergence rate. The current train speed estimated by Kalman filter gain is converged to an actual train speed after a predetermined step. That is, \hat{v}(k|k) approaches v(k) in time. It is possible to estimate a speed robust to uncertain factors such as sensor noise and the like, because the current speed estimation using the extended Kalman filter is based on the dynamics model of train.

The future speed estimation unit (10) estimates a future train speed subsequent to n step, using the designed current train speed using Equations 6 to 10. To this end, it is assumed that there is no change and constant in the tractive force and braking force applied to the current train. The use of dynamics model proposed for estimating the future train speed has been already explained above.

$$\begin{matrix}v ( k + 1 ) = v ( k ) + \frac{Δ T}{m} [ {c}_{2} v ( k ) - {c}_{3} {v ( k )}^{2} ] + \frac{Δ T}{m} [ {T}_{e} ( k ) - {T}_{b} ( k ) ] & [ Equation 11 ] \\ v ( k + 2 ) = v ( k + 1 ) + \frac{Δ T}{m} [ {c}_{2} v ( k + 1 ) - {c}_{3} {v ( k + 1 )}^{2} ] + \frac{Δ T}{m} [ {T}_{e} ( k ) - {T}_{b} ( k ) ] & [ Equation 12 ] \\ v ( k + 3 ) = v ( k + 2 ) + \frac{Δ T}{m} [ {c}_{2} v ( k + 2 ) - {c}_{3} {v ( k + 2 )}^{2} ] + \frac{Δ T}{m} [ {T}_{e} ( k ) - {T}_{b} ( k ) ] & [ Equation 13 ] \\ v ( k + n - 1 ) = v ( k + n - 2 ) + \frac{Δ T}{m} [ {c}_{2} v ( k + n - 2 ) - {c}_{3} {v ( k + n - 2 )}^{2} ] + \frac{Δ T}{m} [ {T}_{e} ( k ) - {T}_{b} ( k ) ] & [ Equation 14 ] \\ v ( k + n ) = v ( k + n - 1 ) + \frac{Δ T}{m} [ {c}_{2} v ( k + n - 1 ) - {c}_{3} {v ( k + n - 1 )}^{2} ] + \frac{Δ T}{m} [ {T}_{e} ( k ) - {T}_{b} ( k ) ] & [ Equation 15 ]\end{matrix}$$

The train speed at k+n step can be predicted using train data of k step, sequentially using the Equations 11 to 15.

To be summarized, the future speed estimation unit (10) estimates the current train speed using the operation data such as train acceleration, tractive force and braking force at kth step, and the future train speed at (k+n) step can be predicted using the estimated current train speed and dynamics model.

The TTSLC calculation unit (20) in FIG. 3 calculates at which time point the train (2) has exceeded the ATP speed limit using the future train speed estimated by the future speed estimation unit (10). That is, the TTSLC calculation unit (20) calculates after which second the train (2) exceeds the ATP speed limit, if it is assumed that the train (2) maintains the current acceleration/deceleration states. It is assumed that the train speed exceeds the ATP speed limit at the nth step, That is, let's assume the following Equation.

v(k+n)≧ATP Speed Limit for Emergency Brake [Equation 16]

where, if k is a current time, the train speed after the n step means that the train (2) exceeds the ATP speed limit. At this time the TTSLC may be calculated by the following Equation.

TTSLC=n×ΔT [Equation 17]

At this time, unit of TTSLC is second, ΔT is a sampling period.

The auxiliary speed controller (30) compares the TTSLC inputted from the TTSLC generating unit (20) and a threshold, and generates an additional braking force to output a deceleration command, if the TTSLC is smaller than the threshold, while the threshold is preset up in consideration of characteristic of the train (2) and dynamics characteristic of a braking device (not shown).

For example, it is assumed that the auxiliary speed controller (30) has set the threshold at three seconds. If the TTSLC calculated by the TTSLC calculation unit (20) is smaller than three seconds, it means that the train speed will exceed the ATP speed limit within three seconds, and it means that an additional service braking must be performed to prevent the train from exceeding the ATP speed limit. Thus, the auxiliary speed controller (30) generates an appropriate additional braking force in response to the TTSLC value to output a deceleration command to the train (2) in consideration of dynamics characteristic of the braking device (not shown).

The ATO speed profile generation unit (40) generates an ATO speed profile, which is a reference speed for automatic train operation, using the ATP speed limit and PSM (Precision Stopping Marker) sensor data received from a PSM (Precision Stopping Marker, not shown) sensor data.

The PSM is installed in front of an entry of a railroad station, and serves to stop a train at a position to be stopped at by reducing an instantaneous speed the moment the train (2) recognizes the PSM installed on a ground near the station while proceeding to the station.

The generation of ATO speed profile is well known to the skilled in the art such that no more further detailed explanation thereto will be made.

The ATO speed profile becomes a target value, and is compared by a comparator (45) with the current speed outputted by a speed sensor (not shown) provided to the train (2), and the speed trace controller (50) determines acceleration or deceleration level based on the compared value to output the acceleration/deceleration commands.

For example, if a train speed limit is 100 km/h during operation between stations, the ATO sped profile generation unit (40) generates an ATO speed profile in response to the speed limit, and compares the ATO speed profile with the current train speed, whereby the speed trace controller (50) performs the speed trace control.

Successively, the moment the train (2) detects the PSM (preferably, a marker detection sensor is attached to a floor of the train (2)), the ATO speed profile for stopping the train is generated, and the speed trace controller (50) performs a control tracing the ATO speed profile (deceleration command outputted), whereby the train (2) can be finally stopped at a designated proper position in the station.

As noted from the foregoing, acceleration/acceleration commands generated by the speed trace controller (50) and the deceleration command generated by the auxiliary speed controller (30) are added by the addition unit (55), which is transmitted to the tractive unit (not shown) and the braking unit (not shown) of the train (2) to control the train speed.

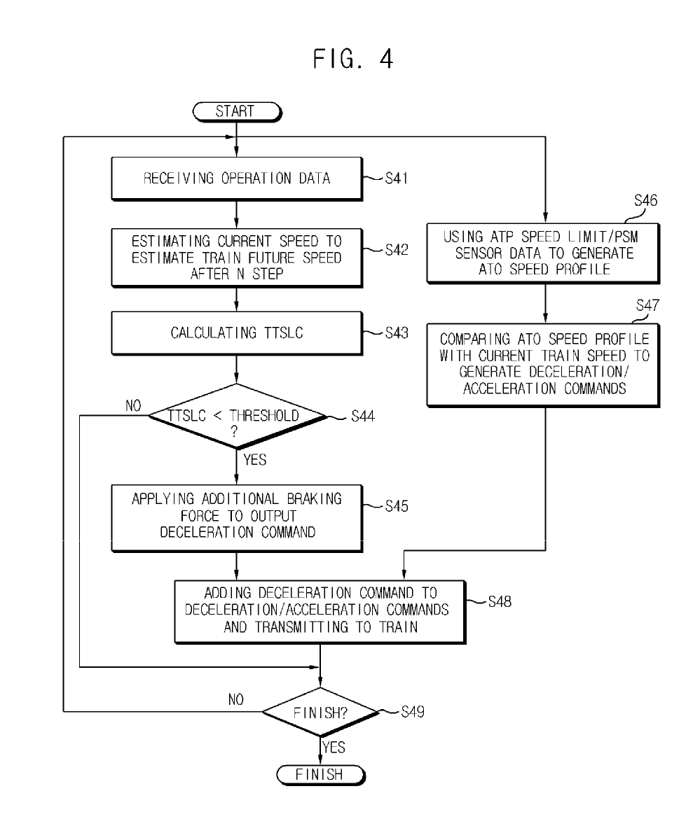

FIG. 4 is a flowchart illustrating a method for controlling train speed according to the present disclosure.

Referring to FIG. 4, the method for controlling train speed includes receiving (S41) an operation data such as tractive force received from a tractive device of a train (2), braking force received from a braking device and acceleration received from an acceleration sensor, estimating, by a future speed estimation unit (10), a current train speed, using the operation data, and estimating a future speed after n step using the current train speed (S42).

Thereafter, the TTSLC calculation unit (20) calculates after what second the train will exceed the ATP speed limit, assuming that the train (2) maintains the current deceleration/acceleration states (S43), the auxiliary speed controller (30) calculates an additional service braking force for decelerating the train speed if the TTSLC is smaller than the threshold, and outputs a deceleration command based on the calculation (S45).

Meanwhile, in addition to S41 to S45, the ATO speed profile generation unit (40) uses the ATP speed limit and the PSM sensor data to generate an ATO speed profile, which is a reference speed for automatic train operation (S46). The reference speed becomes a target value, and the speed trace controller (50) with the reference speed with the current train speed received from a sensor provided to the train (2) to determine deceleration/acceleration levels, and to output deceleration/acceleration commands based thereon (S47).

Although S46 and S47 have been illustrated and explained as being performed subsequent to S41 to S45, the present disclosure is not limited thereto, and both S46 and S47 and S41 to S45 may be simultaneously performed, or S46 and S47 may be performed beforehand, such that individual performances for S46 and S47 and S41 to S45 are guaranteed.

As noted from the foregoing, the train speed can be controlled by adding the deceleration command outputted by the auxiliary speed controller (30) and the deceleration/acceleration commands outputted by the speed trace controller (50) and transmitting to the tractive device and the braking device of the train (2) (S48).

Meanwhile, the apparatus of FIG. 3 may be simplified if the train speed can be obtained by a sensor provided to the train (2).

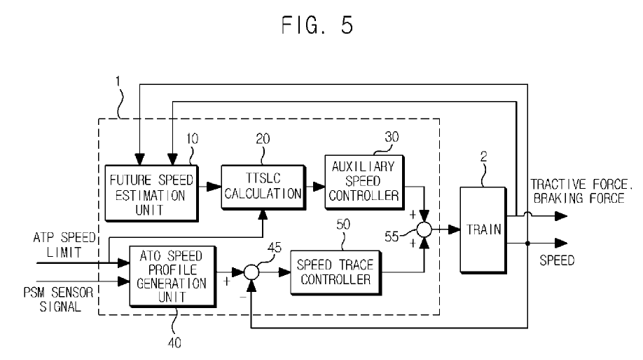

FIG. 5 is a block diagram illustrating an apparatus for controlling train speed according to another exemplary embodiment of the present disclosure, where the future speed controller (10) receives a train speed from a sensor (not shown) provided to the train (2).

Referring to FIG. 5, the future speed controller (10) according to another exemplary embodiment of the present disclosure receives acceleration from an acceleration sensor (not shown), and estimates future speed after n step, immediately using a current train speed without estimating the current train speed using operation data (tractive force of tractive device, braking force of braking device and acceleration).

That is, the system can be simplified in the explanation of FIG. 3, because the future train speed can be immediately estimated without recourse to calculation using Equations 6 to 10.

Referring to FIG. 5, the future speed estimation unit receives the tractive force from tractive device of the train (2), the braking force from braking device and the current train speed from a speed sensor, and estimates the future train speed subsequent to n step, using the dynamics model of the train (2). Explanation to other constituent parts is almost same as that of FIG. 3, such that no further redundancy thereto will be provided.

As apparent from the foregoing, the present disclosure has an industrial applicability in that it enables a train to operate safely by predicting a future speed from a current train speed during automatic train operation, predicting a train speed predicted at a predetermined time when to exceed a preset ATP speed limit, and applying an additional service braking force by the prediction before the train speed reaches the ATP speed limit.

The present disclosure has another industrial applicability in that a minimum safety margin is provided during generation of ATO speed profile to increase a train speed during the train operation, thereby leading to effective train operation by increasing train operation frequency, whereby train safety and availability can be increased.

Meanwhile, the exemplary embodiments of the present disclosure may be embodied in the form of program code embodied in tangible media, such as magnetic recording media, optical recording media, solid state memory, floppy diskettes, CD-ROMs, hard drives, or any other non-transitory machine-readable storage medium. When the exemplary embodiments of the present disclosure are implemented using software, constituent means of the present disclosure may be code segments executing necessary processes. The programs or code segments may be also embodied in the form of program code, for example, whether stored in a non-transitory machine-readable storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the disclosure.

The above-described embodiments of the present invention can also be embodied as computer readable codes/instructions/programs on a computer readable recording medium. Examples of the computer readable recording medium include storage media, such as magnetic storage media (for example, ROMs, floppy disks, hard disks, magnetic tapes, etc.), optical reading media (for example, CD-ROMs, DVDs, etc.), carrier waves (for example, transmission through the Internet) and the like. The computer readable recording medium can also be distributed over network coupled computer systems so that the computer readable code is stored and executed in a distributed fashion.

The above-mentioned apparatus and method for controlling train speed according to the present disclosure may, however, be embodied in many different forms and should not be construed as limited to the embodiments set forth herein. Thus, it is intended that embodiments of the present disclosure may cover the modifications and variations of this disclosure provided they come within the scope of the appended claims and their equivalents.

While particular features or aspects may have been disclosed with respect to several embodiments, such features or aspects may be selectively combined with one or more other features and/or aspects of other embodiments as may be desired.

What is claimed is:

1. An apparatus for controlling train speed, the apparatus comprising: an estimation unit estimating a future speed subsequent to a predetermined time of the train, using an operation data and a dynamics model of the train; a calculation unit calculating a TTSLC {Time-To-Speed-Limit Crossing, a time when the train exceeds an ATP (Automatic Train Protection) speed limit}, using the future speed from the estimation unit; and a first controller outputting a deceleration command by determining an additional braking force, in a case the TTSLC is smaller than a predetermined threshold.

2. The apparatus of claim 1, further comprising: a generation unit generating an ATO (Automatic Train Operation) speed profile using the ATP speed limit and PSM (Precision Stopping Marker) sensor data; and a second controller outputting deceleration/acceleration commands by comparing a current speed provided by the train and the ATO speed profile and by determining speed decrement/increment of the train.

3. The apparatus of claim 1, wherein the operation data includes tractive force, braking force and acceleration.

4. The apparatus of claim 3, wherein the estimation unit estimating a current train speed using the tractive force, the braking force and the acceleration of the train, and estimating a future train speed subsequent to the predetermined time of the train, using the current train speed and the dynamics model of the train.

5. The apparatus of claim 1, wherein the operation data includes tractive force, braking force and acceleration of the train.

6. The apparatus of claim 5, wherein the estimation unit estimates the future train speed subsequent to the predetermined time of the train using the current train speed and the dynamics model of the train.

7. The apparatus of claim 1, wherein the first controller presets the predetermined threshold relative to the TTSLC in consideration of a train characteristic.

8. The apparatus of claim 2, further comprising an adding unit adding deceleration command of the first controller to the deceleration/acceleration command of the second controller and outputs the addition to the train.

9. A method for controlling train speed, the method comprising: receiving an operation data;
estimating a future train speed subsequent to a predetermined time of the train, using the operation data and dynamics model of a train; calculating a TTSLC {Time-To-Speed-Limit Crossing, a time when the train exceeds an ATP (Automatic Train Protection) speed limit}; and outputting a deceleration command by determining an additional braking force, in a case the TTSLC is smaller than a predetermined threshold.

10. The method of claim 9, further comprising estimating a current train speed, using the operation data.

11. The method of claim 10, wherein the operation data includes tractive force, braking force and acceleration of the train.

12. The method of claim 9, wherein the operation data includes tractive force, braking force and current speed of the train.

13. The method of claim 9, further comprising generating an ATO (Automatic Train Operation) speed profile using the ATP speed limit and PSM (Precision Stopping Marker) sensor data; and outputting deceleration/acceleration commands by comparing a current speed provided by the train and the ATO speed profile and by determining speed decrement/increment of the train.

14. The method of claim 9, further comprising adding the deceleration command to the deceleration/acceleration commands and outputting the addition to the train.
